(19) United States
(12) Patent Application Publication
(10) Pub. No.: US 2023/0314031 A1
(43) Pub. Date: Oct. 5, 2023

(54) SYSTEM AND METHOD FOR MODELING, PARAMETER ESTIMATION AND ADAPTIVE CONTROL OF BUILDING HEATING, VENTILATION AND AIR CONDITIONING (HVAC) SYSTEM WITH THE AID OF A DIGITAL COMPUTER

(71) Applicant: Palo Alto Research Center Incorporated, Palo Alto, CA (US)

(72) Inventors: Saman Mostafavi, San Francisco, CA (US); Krishna Moorthy Kalyanam, Campbell, CA (US)

(21) Appl. No.: 17/710,247

(22) Filed: Mar. 31, 2022

(51) Int. Cl. F24F 11/63; G05B 13/04

(52) U.S. Cl. CPC F24F 11/63; G05B 13/042

(57) ABSTRACT

A system and method for modeling, parameter estimation and adaptive control of building heating, ventilation and air conditioning (HVAC) system in built environments with the aid of a digital computer are provided. The system and method disclosed address many of the shortcomings of existing technology. Given metadata regarding a building, such as floor plan and room dimensions, and time series of environmental conditions within the building or associated with the HVAC system within the building, the system and method initializes a base model using the geometric data, the time series, and HVAC system information. Model parameters are iteratively estimated to fit the observed variables using Moving Horizon Estimation (MHE). The updated model is then used for MPC-based (receding horizon control) energy-efficient and comfort-oriented control of the building environment.

### FIELD

This application relates in general to energy conservation and occupant comfort satisfaction, and in particular, to a system and method for modeling, parameter estimation and adaptive control of building heating, ventilation and air conditioning (HVAC) system with the aid of a digital computer.

### BACKGROUND

Buildings are responsible for about 40% of the overall energy consumption in the US. Almost half of this amount is due to heating, ventilation and air-conditioning (HVAC). Accordingly, achieving an optimal control of building HVAC systems has the potential to significantly reduce power consumption while providing, and/or improving, occupant satisfaction and comfort. As extreme weather occurrences become more common in the United States and abroad, and building occupants depend more and more on HVAC systems to insulate themselves from such occurrences, managing the performance and energy consumption associated with HVAC systems becomes of prime importance to protect the individuals by maintaining performance and reducing the downstream potential negative effects on power grid associated with HVAC system-related excessive power usage, as well as financial and environmental effects of suboptimal power consumption.

Recently, predictive control techniques, and in particular Model Predictive Control (MPC), have gained popularity among in the research community towards an optimal control of HVAC. Multiple simulation studies alongside few limited field studies have already shown MPC potential in saving energy (anywhere from 15-65% savings) mostly leveraging pre-cooling and pre-heating via set point optimization, considering multiple future scenarios and picking one that best serves the objectives of the building control problem. These methods specifically have the upper hand in comparison with legacy controllers (most of which are rule based and/or PID systems) in that they are forward looking as opposed to reactive building controllers. However, models needed for such methods are a bottleneck to their cost effective implementation as they are estimated to cost 70% of the labor needed to setup MPC for a building, as described by Atam et al. “Control-oriented thermal modeling of multizone buildings: methods and issues: intelligent control of a building system.” IEEE Control systems magazine 36, no. 3 (2016): 86-111, the disclosure of which is incorporated by reference. The greatest challenge the use of MPC faces in the building control domain is the lack of a reliable mathematical model of the building and the building's HVAC heat transfer dynamics that can be integrated to accurately predict the variables of interest, such as temperature and humidity, for a control horizon of interest. In particular, a good model must realize accurate temperature and humidity predictions into the horizon of interest (>30 minutes). Advanced control algorithms can then use such predictions to provide control input for HVAC system that tracks desired temperature and humidity setpoints to guarantee comfort for the occupants and reduce the overall power consumption, and by extension carbon footprint, of buildings.

Existing mathematical models used for MPC-based building energy control are cumbersome to setup, hard to calibrate and lacking in accuracy. For example, the most popular choice, i.e., physics-based “white-box” model is often synonymous with a nodal characterization of a room, a wall, or loads (such as internal occupancy or equipment gains, and heating or cooling system loads). In this approach, solving the thermal transfer equations is the equivalent of solving a large system of ordinary differential equations (ODEs). This particular approach is well suited for an approximation of the energy consumption along with modeling the space-averaged temperature of a room. TrnSys™ distributed by Thermal Energy System Specialists, LLC of Madison, WI; EnergyPlus® developed under funding of U.S. department of energy; IDA-ICE distributed by EQUA Simulation AB of Sweden, and ESP-r created by University of Strathclyde are just a handful of software that use the nodal approach for building simulations. The models employed by all of these software need various input parameters such as meteorological data, geometrical data, thermo-physical variables or else occupancy, equipment scenario, and a 3D model of a building. As a result, initializing such models for multi-zone buildings can often be a very tedious task that involves many hours of labor for Building Energy Model (BEM) technicians. Also, the models need to be calibrated to historical data. However, a well-known problem is that BEM calibration can be often highly parameterized and under-determined (especially if performed on coarse energy billing data). In addition, the modeling approach makes certain simplifications to reduce the complexity of the thermal mechanisms which in turn introduces additional modeling uncertainty. These uncertainties eventually lead to a real difficulty in evaluating the degree of accuracy of the models that are further disturbed by stochastic inputs such as weather and occupancy.

Therefore, there is a need for an easy to deploy a modeling framework that can be used for controlling building HVAC systems via model predictive control.

### SUMMARY

The system and method disclosed below address many of the shortcomings of existing technology. Given metadata regarding a building, such as floor plan and room dimensions, and time series of environmental conditions within the building or associated with the HVAC system within the building (that may include but are not limited to both indoor and outdoor building air temperature and humidity, solar irradiance, azimuth, etc., as well as HVAC system level data such as inlet and outlet water temperatures for heating and cooling coils that are part of a water based HVAC system, temperature, humidity, and airflow of supply air etc.,) and other measured thermal loads such as occupancy, the system and method initializes a base model using the geometric data, the time series, and HVAC system information. The base model can be a lumped element model, specifically a simplified heat transfer ODE, representing the effect of ambient condition, disturbances such as occupant heat load, solar irradiance, other weather effects and stochastic terms, and control system on the rate of change of the quantities of interest (QoIs) such as one or more zone temperature and humidity. Model parameters are identified through online parameter estimation to fit the model output to the noisy measured variables. Specifically, online parameter estimation is formulated as a Moving Horizon Estimation (MHE). The model is then used for MPC-based energy-efficient and comfort-oriented control of the building environment, regulating QoIs such as temperature and humidity, and generating solutions fast enough for real-time implementation of optimization based predictive building controls.

In one embodiment, a system and method for modeling, parameter estimation and adaptive control of building heating, ventilation, and air conditioning (HVAC) system in built environments with the aid of a digital computer are provided. Data regarding a plurality of zones in a building and data regarding an HVAC system of the building is obtained. A reduced order model for building heat transfer dynamics is stood up using the zone data and the HVAC system data, the reduced order model including two differentiable lumped element physics-based modules, each of the modules a differentiable lumped element physics-based model, each of the models including a plurality of model parameters, state variables, and corresponding constraints on all parameters and variables. Using the reduced order model the physics of heat transfer inside the building envelope, between the building and the outside environment, and within the HVAC system is modeled, wherein the reduced order model represents a rate of change for model states, each model state including one or more quantities of interest (QoIs), each of the QoIs including one or more of the environmental conditions in one or more zones of the building and conditions of one or more of the states of interest for the HVAC system. A plurality of time series is continuously obtained, each time series including a plurality of data points, each data point including one of the QoIs measured at a one of a plurality of time points using the obtained data points in an end-to-end sequential recursive parameter estimation and control algorithm, including: using moving horizon estimation (MHE), a recursive estimation technique for a finite length sliding window, to estimate parameters and states of the reduced order model by solving a linear or nonlinear constrained optimization problem to calibrate the reduced order model parameters and minimize a discrepancy between last Mₚₐₛₜ points of the measured QoIs, where Mₚₐₛₜ is a predefined size of the window, and equivalent model predictions for the same window such that the solution adheres to a feasible set of model dynamics and constraints; obtaining targets including desired environmental conditions within one or more of the zones within the building and desired operating conditions of the HVAC system at a future time; obtaining data regarding one or more of the environmental conditions outside the building and building occupancy data at the future time; and solving a further linear or nonlinear constrained optimization problem that minimizes energy consumption of the HVAC system while satisfying all of the model dynamics and constraint for a predefined future window of size M_{future} and determining a control sequence for the mentioned window; and taking the solution of the further optimization for an immediate time step and applying that solution as a control input for one or more actuators of the HVAC system, wherein the HVAC system operates based on the control input. While the time series are being continuously obtained, for data points measured at each of the subsequent time points, shifting the finite length sliding window and the predefined future window one step into the future, and repeating the recursive parameter estimation and control algorithm, wherein the steps are performed by a suitably-programmed computer.

In a further embodiment, a system and method for modeling, parameter estimation and adaptive control of building heating, ventilation and air conditioning (HVAC) system in built environments with the aid of a digital computer are provided. Data regarding a plurality of zones in a building and data regarding an HVAC system of the building is obtained. A differentiable lumped element physics-based modular model is initialized using the zone data and the HVAC system data, the model including a plurality of parameters representing an effect of environmental condition outside the building and the HVAC system on the rate of change of one or more quantities of interest (QoIs), each of the QoIs comprising one or more of the environmental conditions in one or more zones of the building and conditions of one or more of the elements of HVAC system; The HVAC system is controlled over a time period comprising a plurality of time points, including: predicting using the modular model the QoIs at a plurality of the time points; continuously obtaining a plurality of time series, each time series comprising one of (noisy) measurements obtained at a plurality of time points; following the measurements at each of the time points, comparing the plurality of measured QoIs at that time point and the predicted QoIs at that time point and formulating a moving horizon estimation (as linear or nonlinear constrained optimization) that minimizes the discrepancy between the modular model's predicted QoIs and the measured QoIs; obtaining a target comprising desired environmental conditions within one or more of the zones within the building at a future time; obtaining data regarding one or more of the environmental conditions outside the building at the future time; and solving a (linear or nonlinear) constrained optimization problem to find a control input for one or more actuators of the HVAC system, i.e., performing model predictive building control based on the desired environmental conditions, the estimated modular model, and the outside environmental and occupancy conditions data at the future time, wherein the HVAC system operates as an actuator based on the control input and wherein the steps are performed by a suitably-programmed computer.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for parameter estimation and adaptive control of heating, ventilation and air conditioning (HVAC) system in built environments with the aid of a digital computer in accordance with one embodiment.

FIG. 2 is a diagram showing, for purposes of illustration, an example of devices that form part of the BMS 38 in a single zone 28.

FIG. 3 is a flow diagram showing a method 40 parameter estimation and adaptive control of heating, ventilation and air conditioning (HVAC) system in built environments with the aid of a digital computer.

FIG. 4 is a routine for updating the ROM 16 and optimizing and dispatching the control input for use in the method 40 of FIG. 3 in accordance with one embodiment.

FIG. 5 is a diagram illustrating a resistor-capacitor networks representing a lumped heat transfer model in accordance with one embodiment.

FIG. 6A is a representation of a 5 zone building with a central cooling and variable air volume (VAV) reheat boxes for HVAC system in accordance with one embodiment.

FIG. 6B is a representation of a combination of heat exchanger model and a 5 zone-building in accordance with one embodiment.

FIG. 7A shows simulation validation of zone humidity estimation over time using the system and method (denoted as “MHE”) as compared to simulation values (denoted as “SIM”).

FIG. 7B shows wall temperature estimation over time predicted using the system 10 and method 40 using moving horizon estimation.

FIGS. 8A-8C show diagrams illustrating parameters estimated for a model and control inputs generated based on the HVAC Model that accounts for a building having four zones that need to be controlled.

FIG. 9 is a conceptual diagram showing the flow of at least some data and commands described with reference to FIGS. 1 and 3 in accordance with one embodiment.

### DETAILED DESCRIPTION

The main shortfall in setting up a model predictive control system for buildings is establishing a computationally efficient model with high predictive accuracy at a low cost. This major bottleneck is addressed with model adaptation, specifically using a moving horizon estimation for parameter estimation of reduced order models, to help maintain predictive accuracy at a significantly lower computational cost compared to high fidelity physics-based emulators. As described below, the adaptation of the lumped model constrained by the physics of heat transfer allows to maintain predictive accuracy for a control horizon of interest in building management systems. Specifically, moving horizon estimation (MHE) maintains predictive accuracy by a continuous state and parameters estimation of lumped model. In MHE, unknown (constrained) model parameters are continuously estimated based on recent observed model outputs (using a finite length sliding time window). Continuously updating the parameter values for a reduced-order linear or nonlinear model result in a time-varying model that guarantees that model accurately reflects the state of the system at any point in time. The system and method described below automatically adjust for time-varying disturbances (e.g., occupancy) and exogenous inputs (e.g., solar radiation, weather, and other external environmental conditions). The system and method also take into account all the variable and parameter constraints that are provided by modeling and field experts and are rooted in both physics of the building and HVAC system and the desired (intentional) way they are supposed to be managed.

As a result of these continuous model updates and model constraints, the proposed modeling and calibration framework avoids the prediction errors plaguing typical lumped parameter models over long periods of time and the typical inaccuracies associated with black-box modeling approaches, guaranteeing prediction accuracy in a computationally modest manner, and allowing to both reduce HVAC-related power usage and increase building occupant comfort.

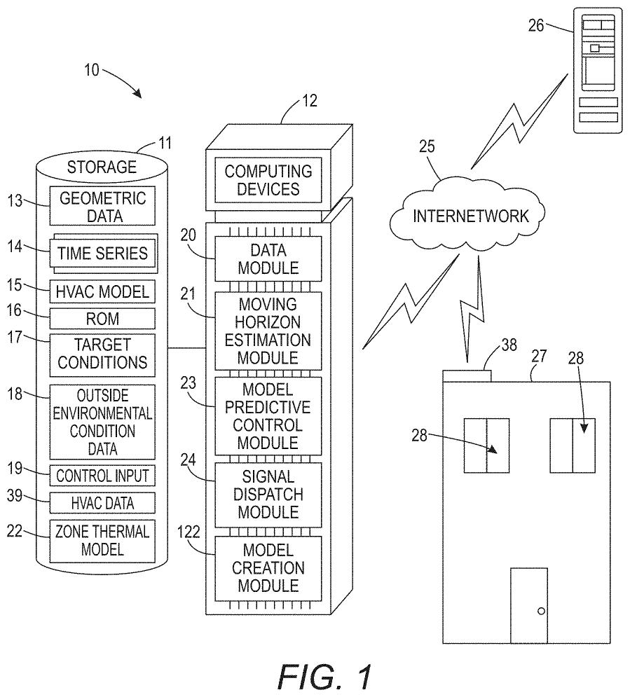

To compliment the advantages of moving horizon estimation, the approach to modeling used by the system 10 and method 40 described below is modular and based on lumped dynamics of zone and HVAC system heat transfer. The modular nature of the model used, allows plug-and-play functionality, allowing to integrate desired parameters of the building. Therefore, the approach can be extended to any number of building types and HVAC systems with virtually no limitation. FIG. 1 is a block diagram showing a system 10 for parameter estimation and adaptive control of heating, ventilation, and air conditioning (HVAC) system in built environments with the aid of a digital computer in accordance with one embodiment. The system includes 10 a storage 11 interfaced to one or more computing devices 12. The one or more computing devices execute a data module 20, which interfaces over an Internetwork 26 (such as the Internet or a cellular network) to a Building Management System (BMS) 34 of a building 27. The building 28 is divided into multiple zones 28, with each zone 28 being at least partially separated from other zones 28 (or the ambient, the outside) by physical barriers (such as walls); in one embodiment, a zone 28 in the building can be a single room, though in a further embodiment, other kinds of zones are possible. For example, a zone 28 could be a hallway, though other kinds of zones 28 are also possible.

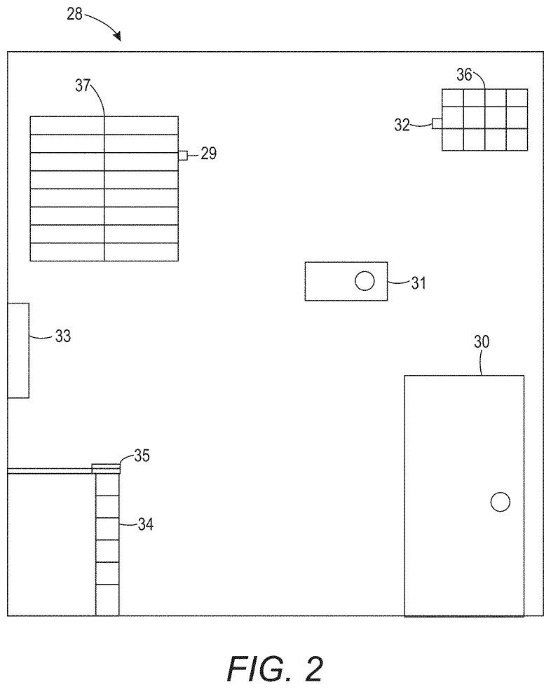

While the portion of the building management system (BMS) 34 shown with reference to FIG. 1 is shown as external to the building 27, the building management system (BMS) 38 can include components that can be both external (such as communication equipment for interfacing with the Internetwork 26) and internal to the building 27, including software (or firmware) executing on at least one central controller (such as a central processor) or multiple microcontrollers that could be present in addition or in place of the central controller and that form part of the devices shown with reference to FIG. 2. FIG. 2 is a diagram showing, for purposes of illustration, an example of devices that form part of the BMS 38 in a single zone 28. Such devices can include sensors 33, such as video sensors (including video cameras, which can note presence of doors 30 and other connections to other zones), chemical sensors (such as carbon monoxide and carbon dioxide sensors), audio sensors, moisture sensors, motion sensors, temperature sensors, distance sensors (such as laser, infrared, or ultrasonic wave sensor), though other kinds of sensors are possible. The devices can further include a user-interfacing device 31, such as a thermostat, though other kinds of devices are possible. The thermostat can be a manual thermostat, or a smart thermostat, such as the Nest Learning Thermostat distributed by Google LLC of Mountain View, CA, though other smart thermostats are possible. The devices can further include environmental condition control devices that control the environmental conditions in the building, such as airflow, water flow, temperature, and humidity (though other environmental conditions are also possible); these devices are part of the building's HVAC system (which is a part of the BMS 27). For example, such environmental control devices can include a heat pump 34, variable refrigerant system, fans, boilers, furnaces, air handlers, air conditioning units, though still other devices making up the HVAC system are possible. For example, such device 32 could include a motor controlling whether vents 36 through which air cooled or heated by the building's HVAC system enters a particular zone 28 are open (and how much they are open), thus controlling how much a particular HVAC system action influence the environmental conditions in a particular zone. Still other devices are possible. For example, a device 29 could include a motor controlling positions of blinds 37 in a zone 28, thus regulating how much sunlight enters the zone 28, and controlling the temperature inside the zone.

The devices that comprise the BMS could be centralized or distributed through the building 27. Likewise, the control over the devices could be centralized or distributed. All of the devices include actuators interfaced (through wired or wireless connection) to the central controller of the BMS 38, and control the devices based on commands from the BMS 38 central controller (though other sources of commands are also possible, as described below) that in turn can receive the control input from the computing devices 12. For example, an actuator 35 of the heat pump 34 could include a microcontroller in control of the heat pump and a wireless transceiver interfaced to the microcontroller through which the microcontroller receives commands from the BMS 38 controller. A similar actuator could be interfaced to the motors of the devices 32, 29. Similarly, actuators could include dampers controlling flow of air through ducts of the building based on commands from the central controller. In one embodiment, one of the actuators, such as a controller of the smart thermostat, could also act as a central controller of the BMS 38. In a further embodiment, the central controller of the BMS 38 could be physically separate from other actuators. In one embodiment, the central controller of the BMS 38 could be located inside the building 27. In a further embodiment, the central controller of the BMS 38 could be located outside of the building 27, and be implemented using a dedicated or distributed processors. In a still further embodiment, the BMS 38 could have no single central controller, and instead each individual actuator of a device would receive control input directly from the computing devices 12.

Returning to FIG. 1, by interfacing with the BMS 38, the data module 20 obtains metadata, such as geometric data 13 regarding the building 27. Such geometric data 13 can include one or more of physical dimensions of the buildings (such as height, length, width, and other zone dimensions, number of zones and their proximity to one another (making up a floor plan of the building), though other dimensions of the building are also possible) elements of the buildings, such as doors and windows 13. The geometric data 13 can be obtained from already prepared floor plans available from third party sources or alternatively, or in addition, from a memory coupled to the BMS 38 central controller. In a further embodiment, the geometric data 13 is created based on the data collected by one or more the sensors 33 that are part of the BMS 38. In one embodiment, the BMS 38 processes the data collected by the sensors 34 to create the geometric data 13 and provides only the prepared geometric data 13 to the data module 20. In a further embodiment, the BMS 38 provides the unprocessed data collected by the sensors 13 to the data module 20, and the data module processes the sensor data to obtain the geometric data 13. The geometric data 13 can be stored in the storage 11.

The metadata obtained by the data module 20 further includes data 39 about the HVAC system, such as the number and kinds of devices (for example heating and cooling coils, variable refrigerant flow system, heat pumps, cooling tower etc.,) and how they connect to each other that are included in the HVAC system. The HVAC data 39 can be obtained from already prepared HVAC models available from third party sources or alternatively, or in addition, from a memory coupled to the BMS 38 central controller. The HVAC data 39 can be stored in the storage 11.

The data module 20 further continuously (when turned on) obtains time-series 14 of values of measurements from one or more sensor 33 in the BMS 38 that describes quantities of interest (QoIs): environmental conditions (such as temperature, humidity, water and air flow) within multiple zones of the building or of a condition an HVAC system element (such as water inlet and outlet temperatures for heating or cooling coils that are part of the HVAC system) in the building over multiple time points. Each time-series 14 is associated with a single measurement node that is used in the estimation and control algorithms. The time-series are stored in the storage 11 as they are obtained. The data points in the time series could be obtained by the data module 33 via interfacing with the BMS 38 (which collects the time series 14 using the sensors 33), though other sources of the time series data are possible. In one embodiment, a data point in the time series could be taken every minute, though other time intervals between the time points are possible.

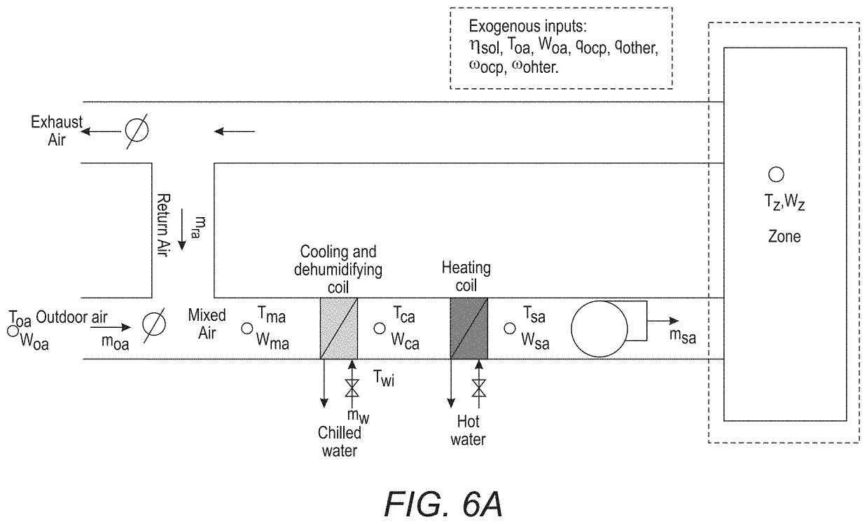

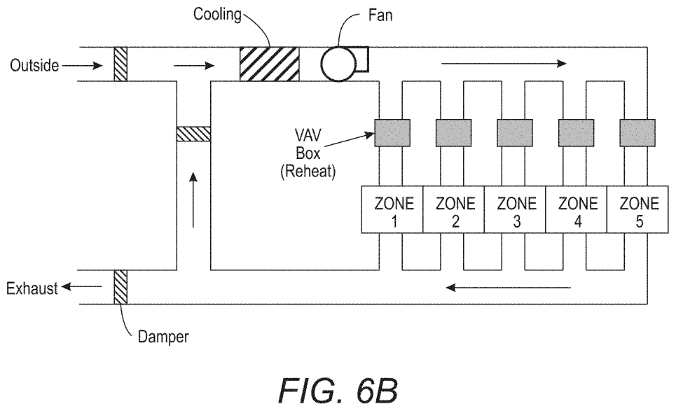

Storage 11 stores an HVAC Model 15 stood up from HVAC data 39 which is a differentiable lumped element physics-based representation of the HVAC system of the building 27, specifically a simplified heat transfer ODE for such system, such as shown in one embodiment with reference to FIG. 6A, representing the effect of and action of the HVAC system on air supplied to the building. HVAC model 15 includes a plurality of model parameters, state variables, and corresponding constraints on all parameters and variables; and the details are provided below.

Dynamics of a Heat Exchanger (HVAC Model 15)

The heat-exchanger (HX) is a thermodynamic system utilized to transfer the energy from one medium to another. In one embodiment, this can be air to chilled water for cooling or hot water to air for heating in a cooling and heating coil-based heat exchanger respectively. In one embodiment, a counter-flow arrangement can be considered in the HX. In one embodiment, a heat exchanger can have air side with mass flow rate mₐ inlet temperature T_{a,in}, outlet temperature T_{a,out} and a water side with mass flow rate m_{w} inlet temperature T_{w,in} outlet temperature T_{w,out}. In the transient state or for example, when m_{w} tuned by a PID controller, the T_{a,out} is temporally evolving.

The rate of change of thermal energy stored in HX is equal to flux of enthalpies, i.e.,

$$\frac{d}{dt} [ ρ {V}_{ex} {C}_{p , a} {T}_{a , out} = {m}_{w} {C}_{p , w} [ {T}_{w , in} - {T}_{w , out} ] - {m}_{a} {C}_{p , a} [ {T}_{a , in} - {T}_{a , out} ]$$

where ρₐ is the density of air at 300° K and Vₑₓ is the volume of the heat exchanger.

In the steady state, where all the quantities are independent of time, the rate of thermal energy lost by water should be equal to the rate of thermal energy gained by the air, i.e., m_{w}C_{p,w}[T_{w,in}−T_{w,out}]=mₐC_{p,a}[T_{a,in}−T_{a,out}] where C_{p,w} and C_{p,a} are the specific heat constants of water and air, respectively. In other words, the right-hand side of equation is zero. In one embodiment, and for simplicity, depending on the temperature range, C_{p,a} is assumed constant to avoid nonlinearity.

Zone thermal model 22 is a differentiable lumped element physics-based system of bilinear equations based on first principal methods that is used to represent the zonal heat transfer inside multi-zone building 27. Computing device 12 stands up zone thermal model 22 via the model creation module 122 using geometric data 13. Zone thermal model 22 includes a plurality of model parameters, state variables, and corresponding constraints on all parameters and variables; and the details are provided below.

Dynamics of a Thermal Zone (Zone Thermal Model 22)

Consider a thermal zone of a temperature T and thermal capacitance C. Let a neighboring thermal zone of temperature Tₙ be separated by a wall of thermal resistance R. Let the heat load or thermal current is Q. Typically, Q is sum of thermal currents due to occupancy Q_{occ} solar irradiation Qₛₒₗ supply air entering the room Q_{hvac} and conduction through a wall. The governing equation of T is given as

$$C \frac{dT}{dt} = [ \frac{{T}_{o} - T}{R} + {Q}_{occ} + {Q}_{sol} + {Q}_{hvac} ]$$

The adjacency matrix of zone is recovered from adjacency information from a floor plan of the building in Geometric Data 13 and is used to represent the dynamic couplings of a multi zone model as a system of bilinear equations based on first principal methods: The ith zone is associated with the ith node of the graph. The (i,j) element of the adjacency matrix represents direct heat transfer between zone thermal zone i and j. In a further embodiment, further dynamics and QoIs may be added to this model without loss of generality. For example, in one embodiment, humidity dynamics of a multi-zone model can also be represented as described by “MPC-based Building Climate Controller Incorporating Humidity,” Raman et al., American Control Conference, 2019, the disclosure of which is incorporated by reference.

ROM 16 is a differentiable reduced order modular model that combines (as described in in dynamics of coupled system) the differentiable lumped element physics-based HVAC model 15 and differentiable lumped element physics-based zone thermal model 22. FIG. 6B is a representation of one such ROM 16 for a HVAC model 15 described above and a 5-zone zone thermal model 22 in accordance with one embodiment, thus being an extension of what is shown with reference to FIG. 6A. Model creation module 122 couples HVAC model 15 to zone thermal model 22 to create ROM 16. ROM 16 includes a plurality of model parameters, state variables, and corresponding constraints on all parameters and variables.

The details of this coupling are described below.

Dynamics of Coupled System (ROM 16)

Referring to FIG. 6B, and assuming for no heat loss or gain in the ducts, the mix air temperature is calculated as:

$${T}_{min} = {r}_{mix} {T}_{amb} + ( 1 + {r}_{mix} ) {T}_{z , avg}$$

$${T}_{z , avg} = \frac{1}{n} {\sum }_{i = 1}^{n} {T}_{z , i}$$

where Tₘᵢₓ represents the mixed air averaged from all the room exhausts T_{z,avg} plus outside air given some mixing ratio rₘᵢₓ. This modular approach is not limited to any particular HVAC setup and/or zone connections and can be easily configured from the floor plan and system information as mentioned before.

HVAC model 15, zone thermal model 22 and ROM 16 are all differentiable models and use automatic differentiation (AD) techniques implemented in open-source packages such as CasADi or JAX, (though other software packages are also possible) to generate efficient derivative information for the model.

Since ROM 16 is a very light (each zone can have as few as 3 parameters), easily extendible to floor plans with many rooms and door/window configurations through the graph based zone heat transfer modeling, and differentiable, ROM 16 is suitable to large scale real-time optimization for building control purposes, curtailing a major bottle-neck in setting up suitable models for real-time advanced predictive controls in medium-size and big buildings with HVAC and floor plan complexities.

Returning to FIG. 1, the moving horizon estimation module 21 uses historical time series 14 data of fixed length horizon from one or more of the zones 28, building occupancy data, and HVAC system to keep the ROM 16 up-to-date, with the ROM 16 including multiple parameters (as described above). These time series 14 can include states such as temperature and humidity variables (measured and/or latent), control inputs such as water flow rates, setpoints, and exogenous inputs such as weather variables and occupancy data.

The moving horizon estimation module 21 updates the ROM 16 based on the received time series 14 that includes states such as temperature and humidity variables (measured and/or latent), control inputs such as water flow rates, setpoints etc., and exogenous inputs such as weather variables and building occupancy data for a fixed horizon of past measurements. In one embodiment, the length of this past horizon can be 4 hours though other horizon are acceptable and can be used based on use case and other preferences.

The MHE methodology is described by Allgöwer, Frank, et al. “Nonlinear predictive control and moving horizon estimation—an introductory overview.” Advances in control (1999): 391-449, the disclosure of which is incorporated by reference. Moving horizon estimation is a state-estimation method that relies on optimization for a fixed past horizon of measurements. The main advantages of MHE are its compatibility with non-linear dynamics and ability to account for physical bounds and inequalities, e.g, temperature dead bands. Assuming parameters as states of the dynamical model, the same technique can be leveraged to achieve parameter estimation. Therefore, the optimization for joint state and parameter estimation problem can be expressed as:

$${min}_{\hat{x} , \hat{p} ∈ ℝ} {‖ x - \hat{x} ‖}_{{P}_{x}}^{2} + {‖ Δ \hat{p} ‖}_{{P}_{p}}^{2} + {\sum }_{k = t - N}^{t - 1} ( ‖ v ( k ) {‖}_{{P}_{v}}^{2} + {‖ w ( k ) ‖}_{{P}_{w}}^{2} )$$

$$s . t . \hat{p} ∈ Ω$$

Where x represents all the states, p the parameters and w, v the state and measurement noise respectively. N represent the length of the horizon. This process is repeated at each time step where the latest measurements are included and oldest one is dropped from the window of interest. where, ∥l∥_{M}:=l^{T}Ml is the weighted vector norm, Pₓ, Pₚ and Pᵥ are symmetric, positive semi-definite matrices with appropriate dimensions. In particular, Pᵥ and P_{w} are inverse of covariance matrices for measurement and process noise and penalize the state and measurement discrepancies. All weight matrices are tuned on historical data. The feasible set Ω imposes the system dynamics as described previously is zone and heat exchanger dynamics section as well as all the state and parameter constraint for an ideal operation of the building as desired by building managers and occupants (e.g., HVAC system temperature and flow deadbands and desired thermostat deadbands) as well as modelers input (e.g., deadlands for parameters).

To solve the optimization in real time, the system 10 leverages differentiable models and automatic differentiation (AD) techniques implemented in open-source packages such as CasADi or JAX, (though other software packages are also possible) that greatly increases the accuracy and time efficiency of the parameter estimation by using gradients in first or second order optimization. Analyzing using moving horizon estimation of the continuously obtained time series 14 as each of additional ones of the values is obtained solves a linear programming (LP) or nonlinear programming (NLP) optimization, depending on modeling and constraint choices, that minimizes a discrepancy between a predefined window of measurement Mₚₐₛₜ and a prediction made for the time point associated with those measurements using the initialized ROM 16. The results is a parameter and state set that reflect the latest state of the ROM 16 according to the most recent measurements (Mₚₐₛₜ points). The iterative optimization is performed every time a new time point in the time series 14 is obtained. Thus, the ROM 16 is maintained up-to-date as the factors that affect the environmental conditions in the zones 28 of the building change over time. If an online update is deemed excessive, less frequent updates can be obtained with no loss of performance.

As the inside of the building 28 is not completely insulated from outside environmental conditions, prediction of environmental conditions within the building, such as temperature and humidity, needs to account for variations in outside conditions. Therefore, the data module 20 obtains data 18 environmental conditions outside of the building. The data 18 include both past environmental conditions for time points in the time series 14 and also environmental conditions predicted for a time frame of interest (time frame during which the environmental conditions inside the building will need to be controlled, as further described below). The environmental conditions (both past and predictions) can be obtained from external sources (such as weather websites) (not shown) via the Internetwork 25, though other sources of the data 18 are also possible.

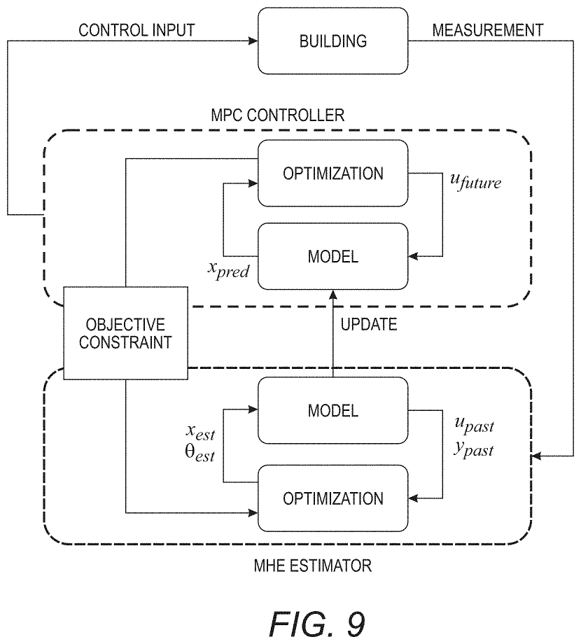

The ROM 16 is used by a model predictive control (MPC) module 23 executed by one or more of the computing devices 12 to predict the environmental conditions (such as temperature and humidity) inside one or more of the zones 28 at a window of interest of size M_{future}, using model predictive control that utilizes the target environmental conditions 17 at the time frame of interest, the ROM 16, and the outside environmental conditions 18 at the time frame of interest. The size of time frame of interest, M_{future}, can be received as part of target conditions 17 that are desired to be created within one or more zones of the building. Such target conditions 17 can be received from a user (such via a computing device 26 associated with the user), with the user specifying the desired environmental conditions inside one or more zones 28 and the time frame for the desired environmental conditions. For example, the user's input may specify that a user desires a room to be 70° F. and a relative humidity to be 40% (though humidity could also be expressed as absolute humidity or specific humidity). In addition, and in one embodiment, the MPC module 23 will try to optimize (minimize) all the heating and cooling power associated with the building based on the predictions for the zones, with the optimization being solved using MPC as an LP or NLP optimization problem. The optimization can be effectively formulated as:

$${min}_{setpoints ∀ zones} {P}_{c} + {P}_{h} s . t . ( setpoints ) ∈ Ω$$

Where Ω imposes the system dynamics as well as all the state and parameter constraint for an ideal operation of the building as desired by building managers and occupants (e.g., HVAC system temperature and flow deadbands and desired thermostat deadbands) as well as modelers input (e.g., deadlands for parameters). P_{c}, Pₕ represent all the cooling and heating loads to be minimized and can be calculated based on system level data either provided by the manufacturer or estimated using the performance curves. In other embodiments, other objectives such as reference tracking may also be included. As was the case with MHE, to solve the optimization in real time, the system 10 leverages differentiable models and automatic differentiation (AD) techniques implemented in open-source packages such as CasADi or JAX, (though other software packages are also possible) that greatly increases the accuracy and time efficiency of the model predictive control by passing the first or second order derivative information to optimization efficiently. The calculated control inputs, i.e, control setpoints, made by the MPC and the user inputs are used by a signal dispatch module 24 executed by one or more of the computing devices 12 to perform optimal control (also referred to as control input below) 19, which includes the amount and kind of work that needs to be done by the devices forming part of the BMS 38, including devices forming part of the HVAC system, to achieve the desired conditions. The signal dispatch module 24 provides control input 19 to the BMS 38 (such as to the control controller) via the Internetwork 26, which in turn commands actuators of the devices to turn the devices on. Thus, the signal dispatch module 24 controls actions of devices making up the BMS 38. FIG. 9 depicts the signal flow diagram between the end-to-end parameter estimation and control modules as described above.

While the one or more computing devices 12 are shown as servers with reference to FIG. 1, in a further embodiment, other types of computing devices 16 can be used, such as laptop computers, desktop computers, mobile phones, and tablets, though still other types of computing devices are possible. The computing devices 12 can include one or more modules for carrying out the embodiments disclosed herein. The modules can be implemented as a computer program or procedure written as source code in a conventional programming language and is presented for execution by the processors as object or byte code. Alternatively, the modules could also be implemented in hardware, either as integrated circuitry or burned into read-only memory components, and each of the computing devices 16 can act as a specialized computer. For instance, when the modules are implemented as hardware, that particular hardware is specialized to perform the computations and communication described above and other computers cannot be used. Additionally, when the modules are burned into read-only memory components, the computer storing the read-only memory becomes specialized to perform the operations described above that other computers cannot. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components. For example, the computing device 12 can include other components found in programmable computing devices, such as input/output ports, network interfaces, and non-volatile storage, although other components are possible. In the embodiment where the computing devices 12 are servers, the server can also be cloud-based or be dedicated servers. In one embodiment, the computing devices can use off the shelf (COTS) solver, IpOpt and an open-source python wrappers (such as CasADi or JAX, though other software packages are also possible) and for implementing the modules, though other implementation is also possible.

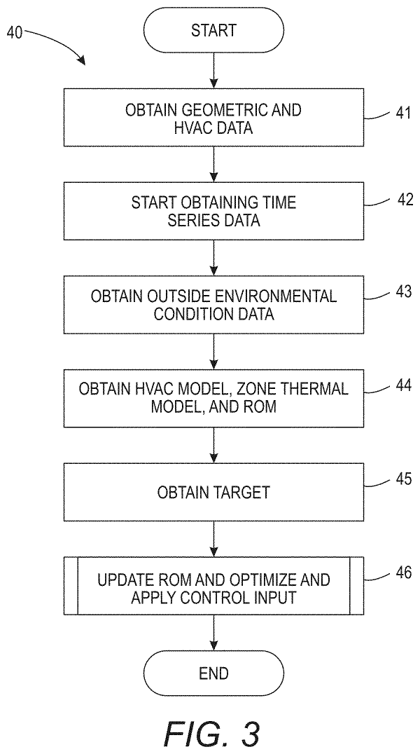

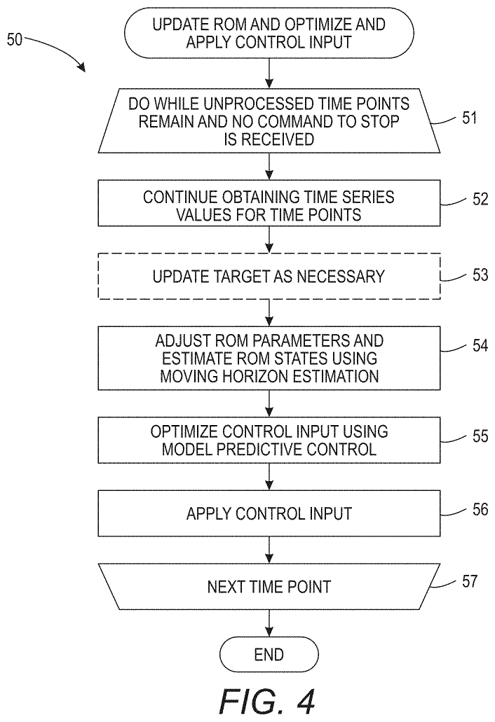

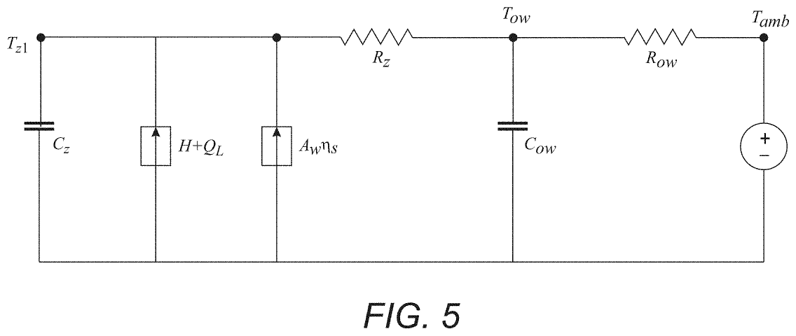

The use of the MHE and the MPC for performing adaptive HVAC control and implementing a recursive parameter estimation and control algorithm that optimizes HVAC system power usage while maintaining applicant comfort can be described as a method performed by the system 10 of FIG. 1. FIG. 3 is a flow diagram showing a method 40 for parameter estimation and adaptive control of heating, ventilation and air conditioning (HVAC) system in built environments with the aid of a digital computer. Geometric data 13 regarding a building 27 and data 39 regarding the HVAC system are obtained, as described above (step 41). Collection of data points in the time series 42 is initialized and continued for the duration of the execution of the method (step 42). Outside environmental data 18, including data 18 for time points that have already occurred and predictions for time points in a time frame of interest in the future, is obtained (step 43). The HVAC model 15, the zone thermal model 22, and the ROM 16 are obtained as described above (step 44). If not previously obtained from a previous iteration of the method 40, an environmental condition target 17 is obtained as described above (step 45). The ROM 16 is updated and a control input 19 for the future time frame of interest is optimized and dispatched using MPC as further described below with reference to FIG. 4 (step 46) and ending the method 40, with MPC being used to solve an LP or NLP optimization problem, as described above, actuating one or more devices making up the HVAC system to achieve the desired conditions for one or more zones 28 of the building.

FIG. 4 is a routine for updating the ROM 16 and optimizing and dispatching the control input for use in the method 40 of FIG. 3 in accordance with one embodiment. An iterative processing loop (steps 51-57) is performed while unprocessed data points in the time series 14 remain and while no command to stop the method 40 is received (such as from the user). The time series 14 are continued being obtained (step 52). Optionally, if additional data (such as an additional user commands) are received, the target 17 is updated (step 53). ROM 16 parameters are adjusted and ROM 16 states are estimated using Moving Horizon Estimation (step 54). Control input 19 is generated based on the ROM 16 as updated in step 54 using Model Predictive Control (step 55) and applied via the BMS 38 (step 56). The iterative processing loop moves to the next time point (step 57) and returning to step 51 (while shifting the finite length sliding window and the predefined future window one step into the future), as long as the command to stop the method 40 has not been received. If such command to stop has been received, the routine 50 (and the method 40) ends.

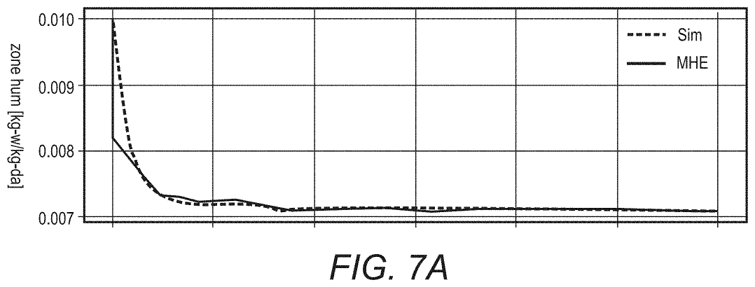

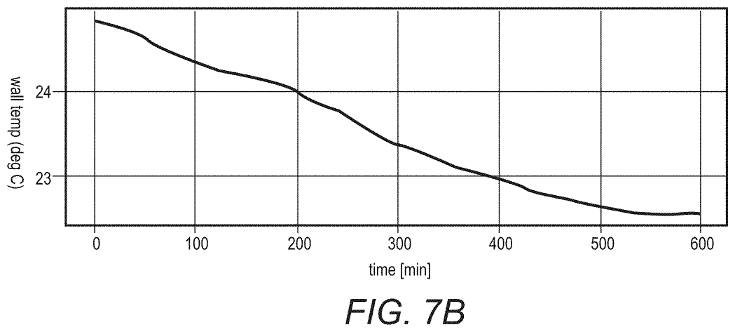

The system 10 of FIG. 1 and the method 40 of FIG. 3 provide multiple advantages over preexisting technology. In particular, the use of model adaptation ensures a better predictive accuracy over state-of-the-art. This ensures more efficient controls that enables further possibility of energy optimization, responding to both grid and occupant demands. Another advantage is the modularity of the approach which ensures scalability and interoperability. Furthermore, composing differentiable models, as is done by the disclosed system 10 and method 40, provides first and second order derivatives for an online implementation of the of the shelf LP and NLP solvers whereas convergence of optimization in a timely manner can be very hard to achieve for other expensive models and optimality of solution have no guarantees in gradient-free optimization. Furthermore, posing the optimization as is, provides guarantees for safety and user preference by adhering to feasible dynamics and inequality constraints for occupant preferences. FIG. 6A shows simulation validation of zone humidity estimation over time using the system and method (denoted as “MHE”) as compared to simulation values (denoted as “SIM”). FIG. 6B shows wall temperature estimation over time predicted using the system 10 and method 40 using moving horizon estimation. FIGS. 7A and 7B show residuals and normalized parameter values plotted against converged analysis. Finally, the scalable graph-based zone model, the modularity of the approach for coupling zone and HVAC system dynamics, and differentiability of the models guarantees scalability of online optimization in both parameter estimation and control tasks to a large number of zones.

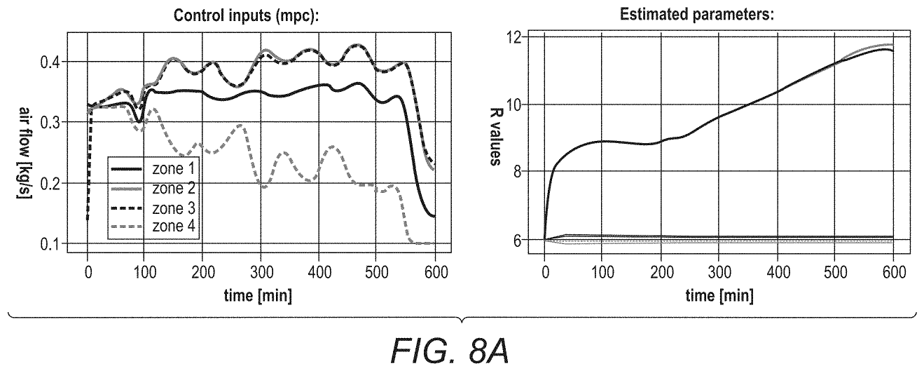

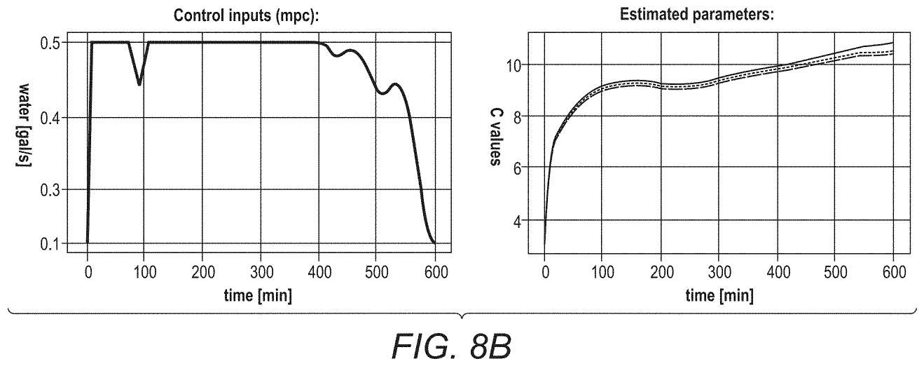

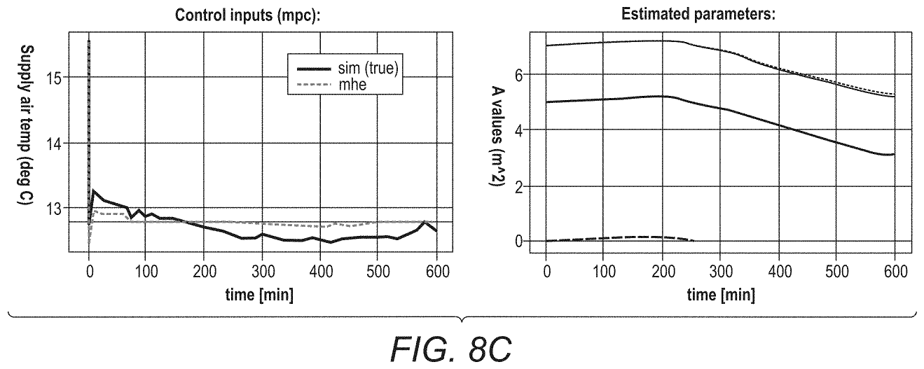

As a result, the system 10 and method 40 can be used to control environmental conditions in a large number of zones 28 at the same time. FIGS. 8A-8C show diagrams illustrating parameters estimated for a model and control inputs generated based on the ROM 16 that accounts for a building 27 having four zones 28 that need to be controlled. FIGS. 8A-8CC shows temperature and humidity in the four zones based on the control input. Other numbers of zones 28 in the building are also possible.

At least some of the flow of data and commands described above with reference to FIGS. 1 and 3 can also be conceptually represented with reference to FIG. 9. FIG. 9 is a conceptual diagram showing the flow of at least some data and commands described with reference to FIGS. 1 and 3 in accordance with one embodiment.

While the invention has been particularly shown and described as referenced to the embodiments thereof, those skilled in the art will understand that the foregoing and other changes in form and detail may be made therein without departing from the spirit and scope of the invention.

What is claimed is:

1. A method for modeling, parameter estimation and adaptive control of building heating, ventilation, and air conditioning (HVAC) system in built environments with the aid of a digital computer, comprising steps of:
obtaining data regarding a plurality of zones in a building and data regarding an HVAC system of the building;
standing up a reduced order model for building heat transfer dynamics using the zone data and the HVAC system data, the reduced order model comprising two differentiable lumped element physics-based modules, each of the modules a differentiable lumped element physics-based model, each of the models comprising a plurality of model parameters, state variables, and corresponding constraints on all parameters and variables;
modeling using the reduced order model the physics of heat transfer inside the building envelope, between the building and the outside environment, and within the HVAC system, wherein the reduced order model represents a rate of change for model states, each model state comprising one or more quantities of interest (QoIs), each of the QoIs comprising one or more of the environmental conditions in one or more zones of the building and conditions of one or more of the states of interest for the HVAC system;
continuously obtaining a plurality of time series, each time series comprising a plurality of data points, each data point comprising one of the QoIs measured at a one of a plurality of time points using the obtained data points in an end-to-end sequential recursive parameter estimation and control algorithm, comprising:
using moving horizon estimation (MHE), a recursive estimation technique for a finite length sliding window, to estimate parameters and states of the reduced order model by solving a linear or nonlinear constrained optimization problem to calibrate the reduced order model parameters and minimize a discrepancy between last Mₚₐₛₜ points of the measured QoIs, where Mₚₐₛₜ is a predefined size of the window, and equivalent model predictions for the same window such that the solution adheres to a feasible set of model dynamics and constraints;
obtaining targets comprising desired environmental conditions within one or more of the zones within the building and desired operating conditions of the HVAC system at a future time;
obtaining data regarding one or more of the environmental conditions outside the building and building occupancy data at the future time;
solving a further linear or nonlinear constrained optimization problem that minimizes energy consumption of the HVAC system while satisfying all of the model dynamics and constraint for a predefined future window of size M_{future} and determining a control sequence for the mentioned window; and
taking the solution of the further optimization for an immediate time step and applying that solution as a control input for one or more actuators of the HVAC system, wherein the HVAC system operates based on the control input; and
while the time series are being continuously obtained, for data points measured at each of the subsequent time points, shifting the finite length sliding window and the predefined future window one step into the future, and repeating the recursive parameter estimation and control algorithm, wherein the steps are performed by a suitably-programmed computer.

2. A method according to claim 1, wherein the building heat transfer dynamics comprises a system of bilinear equations based on first principal methods, analogous to resistor-capacitor electrical circuits, for zone dynamics and coupled to HVAC heat transfer dynamics through air exchange in exhaust and supply air vents using the reduced order model.

3. A method according to claim 2, where the reduced order model allows plug-and-play functionality, and which allows the reduced order model to be applied to a plurality of building types and HVAC system types and to be scaled to the plurality of the zones.

4. A method according to claim 2 wherein the accuracy of the reduced order model is maintained via continuous adaptation to time-varying internal and external conditions of the building through the MHE.

5. A method according to claim 3, wherein the model parameters are treated as further states to enable parameter estimation through moving horizon state estimation.

6. A method according to claim 2, wherein the bilinear zone model is established using adjacency information from a floor plan of the building, wherein each node of the adjacency represents a thermal zone inside the building comprising one or more of rooms, corridors, and hallways.

7. A method according to claim 2, wherein the reduced order model is physics-based and differentiable, being based on first principal methods and supporting Automatic Differentiation (AD) to generate efficient derivative information for the reduced order model and to use the derivative information to solve the constrained optimization problems in both MHE and MPC.

8. A method according to claim 7, wherein a sufficiently fast solution that is adequate for real-time building control to the MHE and MPC constrained optimizations is achieved by a calculation of first and second order derivatives at no extra computational cost using a suitably-programmed computer.

9. A method according to claim 1, wherein optimality of the control inputs is achieved via a receding horizon control framework where the latest state and parameter estimates of reduced order model is used to calculate the next control input repeatedly.

10. A method according to claim 1, wherein the environmental desired conditions comprise one or more of a plurality of temperatures, humidity, and airflows.

11. A method according to claim 1, further comprising:
interfacing to a building management system of the building, the building management system comprising a plurality of sensors, to obtain the time series.

12. A method according to claim 11, wherein the time series comprises time series data obtained using sensor feeds of the building management system.

13. A system for modeling, parameter estimation and adaptive control of building heating, ventilation, and air conditioning (HVAC) system in built environments with the aid of a digital computer, comprising steps of:
one or more computer processors configured to:
obtain data regarding a plurality of zones in a building and data regarding an HVAC system of the building;
stand up a reduced order model for building heat transfer dynamics using the zone data and the HVAC system data, the reduced order model comprising two differentiable lumped element physics-based modules, each of the modules a differentiable lumped element physics-based model, each of the models comprising a plurality of model parameters, state variables, and corresponding constraints on all parameters and variables;
model using the reduced order model the physics of heat transfer inside the building envelope, between the building and the outside environment, and within the HVAC system, wherein the reduced order model represents a rate of change for model states, each model state comprising one or more quantities of interest (QoIs), each of the QoIs comprising one or more of the environmental conditions in one or more zones of the building and conditions of one or more of the states of interest for the HVAC system;
continuously obtain a plurality of time series, each time series comprising a plurality of data points, each data point comprising one of the QoIs measured at a one of a plurality of time points using the obtained data points in an end-to-end sequential recursive parameter estimation and control algorithm, comprising:
use moving horizon estimation (MHE), a recursive estimation technique for a finite length sliding window, to estimate parameters and states of the reduced order model by solving a linear or nonlinear constrained optimization problem to calibrate the reduced order model parameters and minimize a discrepancy between last Mₚₐₛₜ points of the measured QoIs, where Mₚₐₛₜ is a predefined size of the window, and equivalent model predictions for the same window such that the solution adheres to a feasible set of model dynamics and constraints;
obtain targets comprising desired environmental conditions within one or more of the zones within the building and desired operating conditions of the HVAC system at a future time;
obtain data regarding one or more of the environmental conditions outside the building and building occupancy data at the future time;
solve a further linear or nonlinear constrained optimization problem that minimizes energy consumption of the HVAC system while satisfying all of the model dynamics and constraint for a predefined future window of size M_{future} and determining a control sequence for the mentioned window; and
taking the solution of the further optimization for an immediate time step and applying that solution as a control input for one or more actuators of the HVAC system, wherein the HVAC system operates based on the control input; and
while the time series are being continuously obtained, for data points measured at each of the subsequent time points, shift the finite length sliding window and the predefined future window one step into the future, and repeating the recursive parameter estimation and control algorithm, wherein the steps are performed by a suitably-programmed computer.

14. A system according to claim 13, wherein the building heat transfer dynamics are modeled as a system of bilinear equations based on first principal methods, analogous to resistor-capacitor electrical circuits, for zone dynamics and coupled to HVAC heat transfer dynamics through air exchange in exhaust and supply air vents using a reduced order model.

15. A system according to claim 14, where the model is modular and allows plug-and-play functionality, and which allows the model to be applied to a plurality of building types and HVAC system types and to be scaled to the plurality of the zones.

16. A system according to claim 14, wherein the accuracy of the reduced order model is maintained via continuous adaptation to time-varying internal and external conditions of the building through the MHE.

17. A method according to claim 16, wherein the model parameters are treated as states to enable parameter estimation through moving horizon state estimation.

18. A system according to claim 17, wherein the bilinear zone model is established using adjacency information from a floor plan of the building, wherein each node of the adjacency represents a thermal zone inside the building comprising one or more of rooms, corridors, and hallways.

19. A system according to claim 14, wherein the reduced order model is physics-based and differentiable, being based on first principal methods and supporting Automatic Differentiation (AD) to generate efficient derivative information for the reduced order model and to formulate and solve the constrained optimization problems in both MHE and MPC's first and second order optimizations.

20. A system according to claim 16, wherein a sufficiently fast solution that is adequate for real-time building control to the MHE and MPC constrained optimizations is achieved by a calculation of first and second order derivatives at no extra computational cost using a suitably-programmed computer.
